(19) United States
(12) Patent Application Publication
(10) Pub. No.: US 2006/0290139 A1
(43) Pub. Date: Dec. 28, 2006

(54) Generating set utilizing falling water flow

(76) Inventor: Akio Takeuchi, Hanishina-gun (JP)

Correspondence Address: SNELL & WILMER LLP, 600 ANTON BOULEVARD, SUITE 1400, COSTA MESA, CA, 92626, US

(21) Appl. No.: 10/531,335

(22) PCT Filed: Jan. 16, 2004
(86) PCT No.: PCT/JP04/00281

§ 371 Date: Apr. 14, 2005

(51) Int. Cl. F03B 13/00

(52) U.S. Cl. 290/54

(57) ABSTRACT

Falling water flow entering from an introduction port (12) into the inside of a cylindrical frame (10) is introduced into each of a plurality of buckets (30), the openings (32) of which face in the upward direction, lined up on an outer surface of one side of a circulating portion (22) of a conveyor disposed inside the cylindrical frame (10) along a passage through which the falling water flow passes. Then, the circulating portion (22) of the conveyor on which the buckets (30) are provided is circulated by kinetic energy and potential energy of the falling water flow introduced into the buckets (30). As a result, a generator (40) connected to a rotary shaft (24) which circulatably supports the conveyer (20) and rotates with the circulation of the conveyer (20) is revolved, thereby generating electric power.

### TECHNICAL FIELD

The present invention relates to a generating set utilizing falling water flow, adapted to rotate a generator by effectively utilizing the energy of falling water flow in a waterfall, a dam in a river, and the like.

### BACKGROUND ART

As one of the methods of obtaining electric power from an energy source which is clean and harmless to the earth environment, there is a generating set adapted to rotate a generator by rotating a water wheel by utilizing falling water flow obtained in the natural world.

However, none of the related art generating sets utilizing a water wheel which is adapted to rotate a generator by utilizing falling water flow has a structure capable of effectively extracting the energy of the falling water flow. These generating sets have not yet reached a level at which a demand for the electric power in the modern society, in which the electric power is consumed in large quantities, is met satisfactorily.

The present invention has been made in view of such problems, and provides a generating set utilizing falling water flow, capable of efficiently extracting the energy of falling water flow obtained from a waterfall, a dam across a river and the like, i.e., from the natural world. An object of the present invention is to provide a generating set utilizing falling water flow, capable as compared with a related art generating set utilizing a waterwheel of greatly improving the quantity of the electric energy generated by the generator adapted to be rotated by utilizing falling water flow.

### DISCLOSURE OF THE INVENTION

To achieve such an object, the generating set utilizing falling water flow according to the present invention is provided with a substantially vertically standing cylindrical frame having a falling water flow introduction port at a top end thereof and a falling water flow discharge port at a lower therethrough. On the inner side of the cylindrical frame in the vertical direction, a conveyor is provided circulatably via rotary shafts in a loop-like tensed state. In the longitudinal direction and along an outer surface of a circulating portion of the conveyor, a plurality of buckets into which the falling water flow is introduced are fixed thereto at regular intervals so that openings of the buckets face in the direction opposite to the direction in which the conveyor is circulated. The buckets, the openings of which face in the upward direction, lined up on the outer surface of one side of the circulating portion of the conveyor are arranged along a passage through which falling water flow moves from the introduction port at the upper end of the cylindrical frame into the inner side of the cylindrical frame. A generator is connected to one of rotary shafts adapted to support the conveyor circulatably and rotate in accordance with the circulation of this conveyor.

In the generating set utilizing falling water flow, having such a structure as is described above, falling water flow entering the introduction port at the upper end of the cylindrical frame and flowing into the inner side of the cylindrical frame further flows into each of the buckets, the openings of which face in the upward direction, lined up on the outer surface of one side of the circulating portion of the conveyor disposed inside the cylindrical frame. The one side of the circulating portion of the conveyor on which the buckets are provided receives the potential energy and kinetic energy (impact force) of the falling water flow which has flowed into the buckets, and is circulated downward with these buckets. As a result, the rotary shaft for circulatably supporting the conveyer rotates with the rotation of the circulating portion of the conveyer. The generator connected to one of the rotary shaft is then rotated, thereby generating electric power.

The buckets which are lined up on the outer surface of the one side of the circulating portion of the conveyor and store the falling water flow having entered therein are moved down with the circulating portion of the conveyor along the outer surface of the one side of the circulating portion. When the openings of the buckets face in the downward direction on the outer surface of the circulating portion at the lower end of the conveyor, the water in the buckets is discharged to the outside thereof. The falling water flow is then discharged to the outside of the cylindrical frame through the discharge port at the lower end of the cylindrical frame. On the other hand, the falling water flow, which enters the introduction port at the upper end of the cylindrical frame and passes through a space in the inner portion of the cylindrical frame without flowing into the buckets, is discharged as it is to the outside of the cylindrical frame through the discharge port at the lower end of the The buckets from which the stored falling water flow has been discharged to become empty are circulated with the circulating portion of the conveyer in the upward direction along the other side of the circulating portion of the conveyor. The buckets are thereby moved and returned to the outer surface of the one side of the circulating portion of the conveyor.

The same operations are carried out repeatedly.

In such a case, a plurality of buckets, the upwardly directed openings of which are lined up at regular intervals along a passage through which the falling water flow entering the introduction port at the upper end of the cylindrical frame and flowing into the inner side thereof passes, continue to descend with the circulating portion of the conveyor over a long distance along the one side of the circulating portion of the vertically long conveyor, keeping the water in the buckets without leakage. Most of the potential energy of the falling water flow run into the interior of the buckets continues to be transmitted via the buckets into which the falling water flow runs for a long period of time to the circulating portion of the conveyor to which the buckets are fixed. At the same time, most of the kinetic energy (impact force) of the falling water flow which has entered the interior of the buckets also continues to be transmitted via the buckets for a long period of time to the circulating portion of the conveyor to which the buckets are fixed. Most of the potential energy and kinetic energy of the falling water flow run into the interior of the buckets is converted effectively into the conveyor circulating energy. As a result, most of the potential energy and kinetic energy of the falling water flow which have entered the interior of the buckets can be utilized effectively without loss as the energy for rotating the generator connected to one of the rotary shafts of the conveyor.

On the other hand, in a generating set utilizing waterwheels, falling water flow enters openings of a plurality of buckets lined up circularly around waterwheels passing successively in a passage for the falling water flow, and the water is put in a temporarily bucket-stored state. The waterwheels receive the potential energy and kinetic energy (impact force) of the falling water flow which has run into the buckets, and thereby rotate. A generator connected to rotary shafts of the waterwheels is rotated to generate the electric power. However, the buckets lined up circularly around the waterwheels passing successively in the passage of the falling water flow changes the state of their openings in a short period of time from an upwardly directed state to a downwardly directed state in accordance with the rotation of the waterwheels. The falling water flow which has run into the interior of the buckets is merely stored therein temporarily in a short period of time, and the water soon flows out from the downwardly directed openings to the outside of the buckets. The water disappears from the interior of the buckets in a short period of time. As a result, in the generating set utilizing waterwheels, only a small part of the potential energy and kinetic energy (impact force) of the falling water flow running into the buckets lined up circularly around the waterwheels passing successively in the passage for the falling water flow can be effectively utilized as the energy for rotating the waterwheels.

For these reasons, in the generating set utilizing falling water flow according to the present invention, the greater part of the potential energy and kinetic energy of the falling water flow can be utilized effectively without loss as the energy for rotating the generator and thereby obtaining electric power as compared with the related art generating set adapted to rotate a generator by utilizing waterwheels.

In the generating set utilizing falling water flow according to the present invention, a funnel for having the falling water flow introduced into the inner side of the cylindrical frame through the introduction port at the upper end of the cylindrical frame may be additionally provided on the same introduction port.

In this case, the falling water flow can be introduced into the cylindrical frame smoothly with no loss without leaking the water to the outside of the introduction port, through the introduction port via the interior of the funnel additionally provided on the introduction port.

In the generating set utilizing falling water flow according to the present invention, a storage tank for temporarily storing the falling water flow introduced into the inner side of the cylindrical frame through the introduction port may be provided.

In this case, falling water flow obtained from a waterfall, a dam in a river, etc. in the natural world can be stored temporarily in the storage tank, and the water temporarily stored in the storage tank can be made to flow into the inner side of the cylindrical frame via the introduction port. Therefore, even when the quantity of the falling water flow obtained from the natural world is unstable and varies to high and low levels, the falling water flow can be continuously flown via the storage tank into the interior of the cylindrical frame in a stable manner by a predetermined quantity at a time. The generator can be rotated stably at a substantially constant speed by utilizing the potential energy and kinetic energy of the falling water flow continuing to run into the cylindrical frame stably by a predetermined quantity at a time. This allows a predetermined quantity of electric power to be obtained from the generator.

In the generating set utilizing falling water flow according to the present invention, guide plates for making the falling water flow run into the interior of the buckets may be provided on outer edges of the openings of the buckets lined up on the outer surface of the circulating portion of the conveyor in the longitudinal direction so that the guide plates stand up diagonally outward opposite to the side of trunk portions of the buckets.

In such a case, most of the falling water flow entering the introduction port and run into the inner side of the cylindrical frame can be introduced by utilizing the guide plates, which are provided on the outer edges of the openings of the buckets, from the upwardly directed openings of the respective buckets lined up on the outer surface of the one side of the circulating portion of the conveyor provided in the passage in which the falling water flow passes, into the buckets smoothly without spilling the water therefrom to the outside of the buckets. The guide plates can prevent most the falling water flow from passing through the inner side of the cylindrical frame without running into the respective buckets lined up on the outer surface of the one side of the circulating portion of the conveyor. The guide plates can also prevent the potential energy and kinetic energy of the falling water flow from not being utilized effectively as the conveying circulating energy.

In the generating set according to the present invention, the conveyor may be made of a combination of a chain and sprockets.

In such a case, the conveyor made of a combination of a chain and sprockets can be circulated reliably in the vertical direction without slippage owing to the falling water flow working as a lubricant passing in the inner side of the cylindrical frame. This allows the generator connected to one of the rotary shafts of the chain supporting sprockets to be rotated reliably in the chain circulating direction in accordance with the circulation of the chain. In this case, the chain can be circulated around the sprockets smoothly with a low meshing resistance by using the falling water flow working as a lubricant passing in the inner side of the cylindrical frame.

### BRIEF DESCRIPTION OF THE DRAWINGS

FIG. 1 is a front view in section showing a rough construction of a generating set utilizing falling water flow according to the present invention;

FIG. 2 is a side view of the generating set utilizing falling water flow according to the present invention;

FIG. 3 is a front view in section showing a rough construction of another mode of generating set according to the present invention.

### BEST MODE FOR CARRYING OUT THE INVENTION

The best mode for carrying out the invention will now be described in accordance with the drawings.

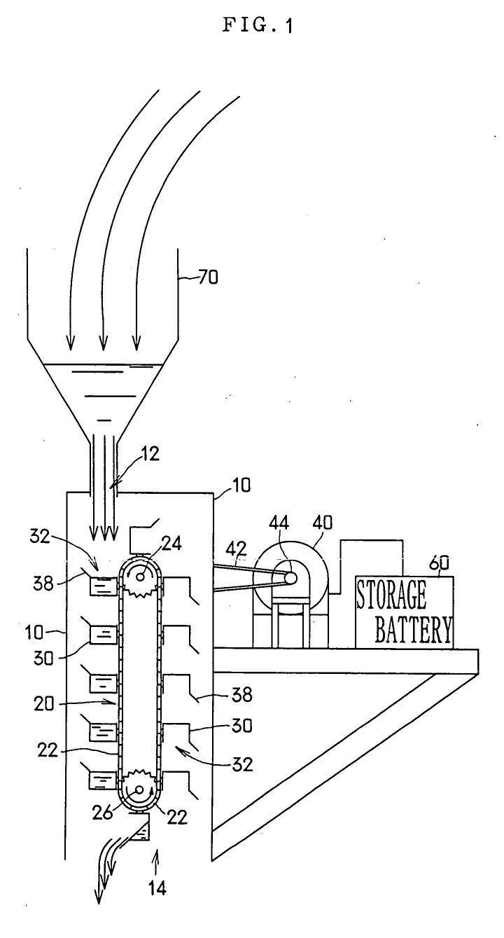

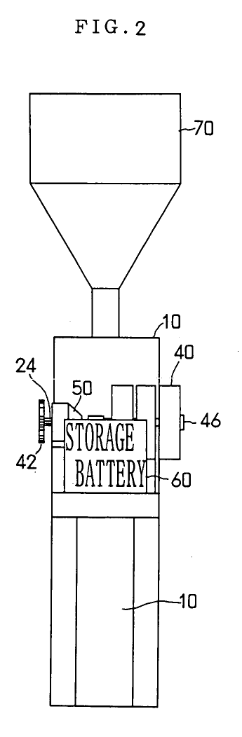

FIG. 1 and FIG. 2 show a preferred mode of embodiment of the generating set utilizing falling water flow according to the present invention.

This generating set is provided with a substantially vertically standing cylindrical frame 10 having at a left side of an upper end thereof an introduction port 12 for introducing falling water flow, and at a lower end thereof a discharge port 14 opened widely for discharging the falling water flow therefrom. In the vertical direction in an inner side of the cylindrical frame 10, a longitudinally elongated conveyor 20 is provided circulatably in the shape of a loop and in a tensed state. A circulating portion 22 of the conveyor 20 is supported circulatably around a pair of upper and lower rotary shafts 24, 26 provided laterally through an inner space in the cylindrical frame 10. A plurality of buckets 30 into which the falling water flow is introduced are fixed in a longitudinally lined up state at predetermined intervals to an outer surface of the circulating portion 22 of the conveyor with openings 32 of the buckets facing in the direction opposite to the direction in which the conveyor 20 is circulated. The buckets 30 lined up on the outer surface of one side of the circulating portion 22 and having upwardly directed openings 32 are arranged along a passage through which the falling water flow which has run into the inner side of the cylindrical frame 10 from the introduction port 12 at the upper end of the cylindrical frame into the interior of the cylindrical frame 10 is passed. A generator 40 is connected to the rotary shaft 24 rotating in accordance with the circulation of the conveyor 20 and supporting the upper end of the circulating portion 22 of the conveyor. The generator 40 and rotary shaft 24 are connected to a driving shaft 46 of the generator via a chain 42, sprocket 44 and a speed increaser 50. The generator 40 receives a rotational force of the rotary shaft 24 which rotates in accordance with the circulation of the circulating portion 22 of the conveyor, to be rotated at a high speed via the speed increaser 50 and the like. The generator 40 is provided with a capacitor 60 by the side thereof, and formed so that the electric power generated thereby can be stored temporarily in the capacitor 60.

The generating set utilizing falling water flow shown in FIG. 1 and FIG. 2 is formed as described above. In this generating set, the falling water flow introduced from the introduction port 12 at a left side of the upper end of the cylindrical frame into the same cylindrical frame 10 can be made to run into each of the buckets 30 which are lined up on the outer surface of the one side of the circulating portion 22 of the conveyor arranged along the passage for the falling water flow and the openings 32 of which face the upward direction. The one side of the circulating portion 22 of the conveyor to which the buckets 30 are fixed can be circulated downward by utilizing the kinetic energy and potential energy of the falling water flow which has been made to flow into the buckets 30. The circulating portion 22 of the conveyor can be circulated vertically around the pair of upper and lower rotary shafts 24, 26. In accordance with the circulation of the circulating portion 22 of the conveyor, the upper rotary shaft 24 supporting the conveyor circulatably can be rotated. The generator 40 connected to the upper rotary shaft 24 via the speed increaser 50 and the like is rotated at a high speed to generate electric power. The electric power generated by the generator 40 can be stored temporarily in the capacitor 60.

The falling water flow which has entered the introduction port 12 at the left side of the upper end of the cylindrical frame and run into the buckets 30 lined up on the outer surface of the one side of the circulating portion 22 of the conveyor is stored in the same buckets 30. These buckets 30 descend along the outer surface of the one side of the circulating portion 22 of the conveyer with the circulating portion 22 of the conveyer. When the openings 32 of the buckets are put in a downwardly directed state on the outer surface of the circulating portion 22 at the lower end of the conveyor, the water can be discharged from the openings 32 to the outside of the buckets 30. The falling water flow discharged to the outside of the buckets 30 can be discharged to the outside of the cylindrical frame 10 through the port 14 at the lower end of the cylindrical frame. On the other hand, the falling water flow entering the introduction port 12 at the left side of the upper end of the cylindrical frame, flowing into the inner side thereof and not running into the buckets 30 but passing through an inner space of the cylindrical frame 10 can be discharged as it is to the outside thereof through the discharge port 14 at the lower end of the cylindrical frame.

The buckets 30, from which the falling water flow has just been discharged, become empty and are circulated upward with the other side of the circulating portion 22 along the outer surface thereof, and thereby moved and returned to the outer surface of the one side of the circulating portion 22 of the conveyor.

The same operations can thereafter be carried out repeatedly.

In these operations, the falling water fall which has run into each of the buckets 30, the openings 32 of which are directed upward, lined up at predetermined intervals on the outer surface of the one side of the circulating portion 22 of the conveyor provided along the passage through which the falling water flow entering the introduction port 12 at the left side of the upper end of the cylindrical frame 10 and running into the inner side of the cylindrical frame passes can be continued to descend over a long distance with the circulating portion 22 of the vertically elongated conveyor along the outer surface of the one side of the circulating portion 22 of the conveyor while the falling water flow run into the buckets 30 being kept as it is without spills. Most of the potential energy of the falling water flow running into the buckets 30 can be continued to be transmitted for a long period of time to the circulating portion 22 of the conveyer to which the buckets 30 are fixed, via the buckets 30 into which the falling water flow has run. At the same time, most of the kinetic energy (impact force) of the falling water flow which has entered the buckets 30 be can continued to be transmitted for a long period of time to the circulating portion 22 of the conveyer to which the buckets 30 are fixed, via the buckets 30 which the falling water flow has run into. Most of the potential energy and kinetic energy of the falling water flow, which has run into the buckets 30, can be effectively converted into the energy for circulating the conveyor 20. As a result, most of the potential energy and kinetic energy of the falling water flow, which has run into the buckets 30, can be utilized effectively without loss as the energy for rotating the generator 40 connected to the rotary shaft 24 of the conveyor, i.e. the electric energy.

In this generating set utilizing falling water flow, a funnel 70 may be additionally provided on the introduction port 12 at the upper end of the cylindrical frame as shown in FIG. 1. The falling water flow obtained from the natural world may be thus rendered to flow into the inner side of the cylindrical frame 10 smoothly without loss through the introduction port 12 without causing the water to leak out to the exterior of the introduction port 12.

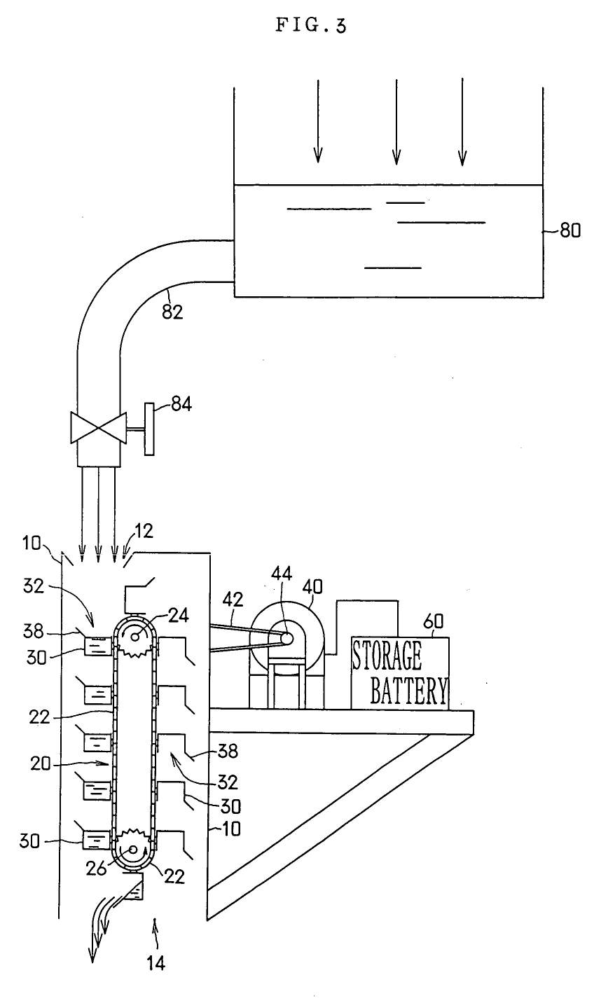

In this generating set utilizing a falling water flow, a large-sized storage tank 80 for temporarily storing the falling water flow which is to be run into the inner side of the cylindrical frame through the introduction port 12 may be provided as shown in FIG. 3. Therefore, the falling water flow obtained from a waterfall, a dam in a river, etc. in the natural world may stored temporarily in the storage tank 80, and then made to flow into the inner side of the cylindrical frame 10 through the introduction port 12. The generating set is preferably formed so that, even when a rate of the falling water flow obtained from a waterfall, a dam in a river, etc. in the natural world is not stabilized but varied to high and low levels, the falling water flow obtained from the natural world can be made to flow continuously into the inner side of the cylindrical frame at a predetermined rate at a time via the interior of the storage tank 80. The generator 40 may be rotated at a substantially constant speed by utilizing the potential energy and kinetic energy of the falling water flow, which continues to be introduced into the inner side of the cylindrical frame 10 stably at a predetermined rate at a time, to allow a predetermined quantity of electric power to be obtained stably from the generator 40. In such a case, a valve 84 may be provided in a discharge passage 82 for the falling water flow from the storage tank as shown in FIG. 3. The generating set may be formed so that the quantity of the falling water flow running from the storage tank 80 into the inner side of the cylindrical frame 19 can be regulated accurately so as to prevent the quantity of the water flow from becoming excessively large or excessively small by regulating the degree of opening and closing of the valve 84 to high and low levels.

This generating set utilizing falling water flow can also be adapted to have both the funnel 70 and storage tank 80. In this case, a generating set utilizing falling water flow, having the effects of both the funnel 70 and storage tank 80 can be provided.

In the generating set utilizing falling water flow as illustrated in FIGS. 1 and 3, the outer edges of the openings 32 of the respective buckets lined up in the longitudinal direction on the outer surface of the circulating portion 22 of the conveyor and fixed thereto may be provided with guide plates 38 for making the falling water flow run into the inside of the bucket 30 smoothly, in such a manner that the guide plates stand up diagonally outward from the portions of the buckets which are on the opposite side of trunk portions thereof. By utilizing the guide plates 38, most of the falling water flow running from the introduction port 12 into the inner side of the cylindrical frame may be introduced into each of the buckets 30 lined up on the outer surface of the one side of the circulating portion 22 of the conveyor provided along the passage through which the falling water flow passes, in such a manner that the water can enter the buckets 30 smoothly without leaking the water from the upwardly directed openings 32 to the outside of the buckets 30. It may thus be prevented that the greater part of the falling water flow passes through the inside of the cylindrical frame 10 in vain without running into each of the buckets 30 lined up on the outer surface of the one side of the circulating portion 22 of the conveyor. Accordingly, most of the potential energy and kinetic energy of the falling water are preferably rendered to be effectively utilized for the circulation of the circulating portion 22 of the conveyor.

In the generating set utilizing falling water flow as illustrated in FIGS. 1 and 3, the conveyer 20 may be formed by a combination of a chain and sprockets, thereby securely circulating the conveyer 20 in the vertical direction without slippage while making use of the falling water flow which passes through the inside of the cylindrical frame 10 as a lubricant. The generator 40 connected to the rotary shaft 24 of the sprocket for supporting the chain may be thus securely rotated in the circulating direction of the chain in accordance with the circulation of the chain of the conveyer 20. In this case, it is preferable to smoothly circulate the chain around the sprockets with reduced engagement resistance by making use of the falling water flow which passes through the inside of the cylindrical frame 10 as a lubricant.

Furthermore, in the generating set utilizing falling water flow as illustrated in FIGS. 1 and 3, the generator 40, the speed increaser 50, the capacitor 60 and other components may be disposed in the outside upper region of the cylindrical frame 10. In this case, the generator 40, the speed increaser 50, the capacitor 60 and other components may be protected by the peripheral wall of the cylindrical frame 10 or the like so that these devices are prevented from splashes of part of the falling water flow and from break down due to the splash of the falling water flow.

### INDUSTRIAL APPLICABILITY

The generating set utilizing falling water flow according to the present invention has a wide range of effective applicability as a source of electricity for the purpose of energy saving, the source being capable of generating electricity by utilizing energy obtained from the nature and thus being friendly to the global environment.

1. A generating set utilizing falling water flow, comprising:
a substantially vertically standing cylindrical frame having an introduction port at its top end for introducing falling water flow and a discharge port at its lower end for discharging the falling water flow so as to pass the falling water flow through the cylindrical frame;
a conveyer circulatably provided inside the cylindrical frame in the vertical direction via a rotary shaft in a loop-like tensed state;
a plurality of buckets disposed in the longitudinal direction along an outer surface of a circulating portion of the conveyor and fixed thereto at predetermined intervals, into which the falling water flow is introduced and the openings of which face in the direction opposite to the circulating direction of the conveyor; and
a generator connected to the rotary shaft which supports the conveyor and rotates with the circulation of the circulating portion of the conveyor, characterized in that the buckets, the openings of which face in the upward direction, lined up on the outer surface of one side of the circulating portion of the conveyor are arranged along a passage through which the falling water flow introduced from the introduction port into the inside of the cylindrical frame passes.

2. A generating set as set forth in claim 1, characterized in that a funnel for introducing the falling water flow into the inside of the cylindrical frame through the introduction port is provided on the introduction port at the upper end of the cylindrical frame.

3. A generating set as set forth in claim 1, characterized in that a storage tank for temporarily storing the falling water flow to be introduced into the inside of the cylindrical frame through the introduction port is provided.

4. A generating set as set forth in claim 1, characterized in that guide plates for introducing the falling water flow into the buckets are provided on outer edges of the openings of the respective buckets lined up on the outer surface of the circulating portion of the conveyor in the longitudinal direction in such a manner that the guide plates stand up diagonally outward opposite to the trunk side of the buckets.

5. A generating set as set forth in claim 1, characterized in that the conveyer is formed by a combination of a chain and sprockets.

6. A generating set as set forth in claim 2, characterized in that a storage tank for temporarily storing the falling water flow to be introduced into the inside of the cylindrical frame through the introduction port is provided.

7. A generating set as set forth in claim 2, characterized in that guide plates for introducing the falling water flow into the buckets are provided on outer edges of the openings of the respective buckets lined up on the outer surface of the circulating portion of the conveyor in the longitudinal direction in such a manner that the guide plates stand up diagonally outward opposite to the trunk side of the buckets.

8. A generating set as set forth in claim 3, characterized in that guide plates for introducing the falling water flow into the buckets are provided on outer edges of the openings of the respective buckets lined up on the outer surface of the circulating portion of the conveyor in the longitudinal direction in such a manner that the guide plates stand up diagonally outward opposite to the trunk side of the buckets.

9. A generating set as set forth in claim 2, characterized in that the conveyer is formed by a combination of a chain and sprockets.

10. A generating set as set forth in claim 3, characterized in that the conveyer is formed by a combination of a chain and sprockets.

11. A generating set as set forth in claim 4, characterized in that the conveyer is formed by a combination of a chain and sprockets.

12. A system for generating electrical power from water flow, comprising:
a frame unit;
a first shaft rotably mounted on the frame unit;
a generator operatively mounted to the shaft for generating electricity as the shaft rotates;
a second shaft rotably mounted on the frame unit;
an elongated endless conveyor member operatively supported on the first and second shafts, the conveyor member having a plurality of spaced bucket projections extending outward from an exterior surface of the conveyor member for receiving and temporarily retaining water; and
a funnel member capable of receiving and directing water, the funnel member directs the water above and to one side of the conveyor member that juxtapositions the bucket members to receive and temporarily retain water so that release of the water to fall by gravity will impact the respective spaced bucket projections to drive the conveyor member to rotate.

13. The system as set forth in claim 12 further including an inclined guide plate on an outer edge of each bucket projection extending parallel to the exterior surface of the conveyor member.

14. The system as set forth in claim 13 wherein the conveyor member includes a chain that engages complementarily sprockets on the respective first and second shafts.

15. The system as set forth in claim 14 further including a storage tank for holding water connected to the funnel member.

16. The system as set forth in claim 15 further including a speed increaser unit is connected between the first shaft and the generator to increase the rotary speed applied to the generator.

17. The system as set forth in claim 16 further including a storage battery connected to the generator.

18. The system as set forth in claim 17 further including a cylindrical outer housing extending around the sides of the frame unit.
